(19) United States
(12) Patent Application Publication
(10) Pub. No.: US 2021/0252474 A1
(43) Pub. Date: Aug. 19, 2021

(54) GRANULATION-PURPOSE FIBROUS BINDER

(71) Applicant: LIXIL Corporation, Tokyo (JP)

(72) Inventors: Kazuhiro SATO, Tokyo (JP); Masanari TOYAMA, Tokyo (JP); Hirohito NAKAJIMA, Tokyo (JP); Takeyuki YAMAMOTO, Tokyo (JP); Takahisa ISHIKAWA, Tokyo (JP); Hiroki MAENAMI, Tokyo (JP); Hajime OTA, Tokyo (JP); Takao OTSUKA, Tokyo (JP); Daiki HONDA, Tokyo (JP); Hiroto TASAKI, Tokyo (JP)

(21) Appl. No.: 16/972,649

(22) PCT Filed: Apr. 1, 2019
(86) PCT No.: PCT/JP2019/014498

§ 371 Date: Dec. 7, 2020

(30) Foreign Application Priority Data
Jun. 8, 2018 (JP) 2018-110661

(51) Int. Cl. B01J 20/20; C02F 1/28; C02F 1/42; B01J 20/28; C01B 32/384

(52) U.S. Cl. CPC B01J 20/20; C02F 1/283; C02F 1/42; C01P 2004/03; C01B 32/384; B01J 20/2803; B01J 20/28004

(57) ABSTRACT

A fibrous granulation binder that is for active carbon granules that are formed from aggregates of active carbon particles and has a D50 particle size, as measured by laser diffraction, of 3.5-86.7 μm. When a fibrous binder is used to produce active carbon granules, setting an appropriate particle size for the fibrous binder makes it possible to reliably produce high-strength active carbon granules.

This application is based on and claims the benefit of priority from Japanese Patent Application No. 2018-110661, filed on 8 Jun. 2018, the content of which is incorporated herein by reference.

### TECHNICAL FIELD

The present invention relates to a granulation-purpose fibrous binder.

More specifically, the present invention relates to a fibrous binder for producing active carbon granules for water purification.

### BACKGROUND ART

Conventionally, tap water purified with a water purifier is used as drinking water and water for cooking.

In general, a water purifier incorporates a filter and the like, together with active carbon or a molded body of active carbon particles as a filter medium.

For example, a water purifier has been proposed which incorporates a molded body of active carbon particles such as powder of coconut shell active carbon.

Meanwhile, to facilitate handling of active carbon, use of active carbon granules has been under consideration.

The active carbon granules are produced using a granulation-purpose binder.

In particular, in the case of using a fibrous binder, active carbon granules are comprising active carbon particles and the fibrous binder that bind to each other as a consequence of, for example, entanglement of the active carbon particles with the binder fibers, and hydrogen bonds formed between oxygen atoms present on the surface of active carbon and hydroxy groups of the binder fibers (Patent Document 1).
Patent Document 1: Japanese Unexamined Patent Application, Publication No. 2017-178697

### DISCLOSURE OF THE INVENTION

### Problems to be Solved by the Invention

When active carbon granules are produced using the fibrous binder described above, if the binder fibers have a large fiber diameter and a long fiber length, it is difficult to granulate active carbon, and to obtain granules in the form of a secondary particle. In addition, the thus produced granulated bodies have a low strength so that the granulated bodies placed in a water purifier are prone to collapsing when water passes therethrough.

In view of the foregoing, it is an object of the present invention to determine a suitable particle size range of binder fibers for production of active carbon granules using a fibrous binder, and to achieve more reliable production of active carbon granules or production of active carbon granules with a higher strength.

### Means for Solving the Problems

A first aspect of the present invention is directed to a granulation-purpose fibrous binder for producing an active carbon granule comprising an aggregation of active carbon particles. The granulation-purpose fibrous binder has a median size D₅₀, as measured by a laser diffraction method, of 3.5 μm to 86.7 μm.

A second aspect of the present invention is an embodiment of the first aspect. In the second aspect, the median size D₅₀ is more preferably 13.8 μm to 59.0 μm.

A third aspect of the present invention is an embodiment of the first or second aspect. In the third aspect, it is more preferable that a particle diameter D₉₀ is 11.0 μm to 522.3 μm.

A fourth aspect of the present invention is an embodiment of any one of the first to third aspects. In the fourth aspect, it is more preferable that a particle diameter D₁₀ is 0.8 μm to 18.2 μm.

A fifth aspect of the present invention is an embodiment of any one of the first to fourth aspects. In the fifth aspect, the granulation-purpose fibrous binder may be made of an acrylic material or cellulose.

A sixth aspect of the present invention provides a filter medium granule for treating water, the filter medium granule including the granulation-purpose fibrous binder according to any one of the first to fifth aspects.

A seventh aspect of the present invention is an embodiment of the sixth aspect. In the seventh aspect, the filter medium granule for treating water may further include active carbon or an ion exchanger.

### Effects of the Invention

The present invention makes it possible to determine a suitable particle size range of binder fibers for production of active carbon granules using a fibrous binder, and to achieve more reliable production of active carbon granules or production of active carbon granules with a higher strength.

### BRIEF DESCRIPTION OF THE DRAWINGS

FIG. 1 is a schematic diagram showing, on an enlarged scale, a cross section of the vicinity of a surface of a conventional active carbon particle;

FIG. 2 is a schematic diagram showing, on an enlarged scale, a cross section of the vicinity of a surface of an active carbon particle according to the present embodiment;

FIG. 3 is a graph showing particle size distribution of a fibrous binder;

FIG. 4 is a scanning electron microscope (SEM) photograph of a conventional active carbon particle;

FIG. 5 is an SEM photograph of an active carbon granule according to the present embodiment;

FIG. 6 is an SEM photograph of an active carbon granule according to the present embodiment;

FIG. 7 is a graph showing particle size distribution of a fibrous binder according to the present embodiment; and

FIG. 8 is a graph showing particle size distribution of a fibrous binder according to the present embodiment.

### PREFERRED MODE FOR CARRYING OUT THE INVENTION

Active carbon granules according to the present embodiment are usable in, for example, a water purification cartridge incorporated in a water purification apparatus for purifying water to be treated, such as tap water.

The active carbon granules of this type remove removal targets contained in water to be treated, by oxidative decomposition or adsorption.

Examples of the removal targets include odor substances in tap water, such as free residual chlorine, and organic compounds in tap water, such as trihalomethane.

<Active Carbon Granule>

The active carbon granule according to the present embodiment includes active carbon particles and a granulation-purpose fibrous binder.

As the active carbon particles, active carbon produced from any starting material can be used.

Specifically, usable active carbon can be produced by way of activating carbon obtained from carbonizing coconut shell, coal, phenolic resin, or the like at a high temperature. Activation is a reaction which changes a carbonaceous raw material into a porous material by developing micropores of the carbonaceous raw material, and is caused by, for example, a gas such as carbon dioxide or water vapor, or by a chemical. The majority of such active carbon particles comprise of carbon, whereas there are some active carbon particles comprising a compound of carbon and oxygen or a compound of carbon and hydrogen.

The active carbon particles according to the present embodiment preferably have a median particle diameter D₁ of 40 μm or less.

When the median particle diameter of the active carbon particles is within this range, the active carbon granules including the active carbon particles increase in adsorption amount of the removal targets per unit mass.

This is because the specific surface area of the active carbon granule including the active carbon particles increases with a decrease in the median particle diameter of the active carbon particles.

Note that the median particle diameter D₁ of the active carbon particles may be greater than 40 μm, but in this case, the necessity to granulate the active carbon is low because the active carbon particles are less prone to densification and the resistance to water flow is less likely to increase.

Further, as will be described later, from the viewpoint of an adsorption rate of the removal targets, it is preferable that the median particle diameter of the active carbon particles is small.

In the present embodiment, the median particle diameter D₁ of the active carbon particles is a value measured by a laser diffraction method, and refers to the value of a 50% diameter (D₅₀) in volume-based cumulative fraction.

For example, D₁ is measured by Microtrac MT3300EXII (a laser diffraction/scattering-type particle diameter distribution measurement device, manufactured by MicrotracBEL Corp.).

The active carbon granules including the above-described active carbon particles according to the present embodiment have a high adsorption rate with respect to the removal targets.

Water purification cartridges included in water purifiers are required to have extremely high adsorption rates.

For example, a common water purification cartridge has a capacity of about 35 cc. If tap water as water to be treated flowing at a flow rate of, for example, 2500 cc/min is made to permeate the common water purification cartridge, it is calculated that all the water in the cartridge is replaced in about 0.8 seconds.

Therefore, when the active carbon has an insufficient adsorption rate, the removal targets cannot be removed to a sufficient extent, depending on the flow rate of the water to be treated.

Here, the active carbon particles according to the present invention have a smaller particle diameter than the conventional active carbon particles.

The relationship between the adsorption rate and the particle diameter of active carbon will be described with reference to the accompanying drawings.

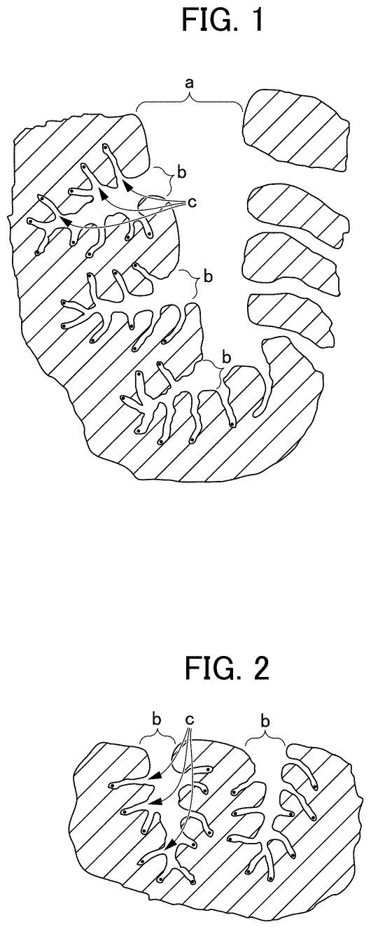

FIG. 1 is a schematic diagram showing, on an enlarged scale, a cross section of the vicinity of a surface of an active carbon particle (having a particle diameter of 80 μm) used in a conventional water purifier.

FIG. 2 is a schematic diagram also showing, on an enlarged scale, a cross section of the vicinity of a surface of an active carbon particle of the present embodiment having a relatively small diameter (e.g., a particle diameter of about 10 μm).

In FIGS. 1 and 2, the reference character a denotes a macropore having a diameter of 50 nm or greater, the reference character b denotes a mesopore having a diameter of 2 nm to 50 nm, and the reference character c denotes a micropore having a diameter of 2 nm or less.

Portions with a black dot are reaction sites where the removal targets are adsorbed.

Each pore in the surface of active carbon adsorbs a substance that matches with the size of the pore. As shown in FIGS. 1 and 2, the majority of the reaction sites are present in the micropores c.

This is because water treatment principally removes, as the removal targets, substances having a relatively small molecular weight, such as free chlorine and CHCl₃ as trihalomethane.

In FIG. 1, the removal targets, such as CHCl₃, which have entered through the surface of active carbon, pass through the macropores a, the mesopores b, and the micropores c, and then, arrive at the reaction sites.

In contrast, in FIG. 2, the removal targets, such as CHCl₃, which have entered through the surface, pass through the mesopores b and the micropores c, and then, arrive at the reaction sites. Thus, the distance to the reaction sites in FIG. 2 is shorter than in FIG. 1.

Consequently, the active carbon particles according to the present embodiment have a higher adsorption rate than the conventional active carbon particles.

The fibrous binder included in the active carbon granule according to the present embodiment is fine fibers which are called, for example, microfibers or nanofibers, and are entangled with the active carbon particles so as to contribute to formation of the granulated body.

Examples of such microfibers and nanofibers include cellulose microfibers and cellulose nanofibers.

Cellulose is known to be produced from trees, plants, some animals, fungi, and the like.

Fibers with a structure in which cellulose forms a fibrous aggregation and having a fiber diameter of micro size are called cellulose microfibers. Such fibers having a fiber diameter smaller than micro size are called cellulose nanofibers.

In nature, cellulose nanofibers exist in a firmly aggregated state due to interactions such as hydrogen bonds between the fibers, while a cellulose nanofiber as a single fiber hardly exists.

For example, pulp used as a raw material for paper is obtained by defibrating wood, and has a fiber diameter of micro size ranging from about 10 μm to about 80 μm. Pulp has a fibrous form in which cellulose nanofibers are firmly aggregated by interactions such as the hydrogen bonds described above.

By further defibrating the pulp, cellulose nanofibers can be obtained.

Examples of the defibration method include chemical processing such as an acid hydrolysis method and mechanical processing such as a grinder method.

The active carbon granule according to the present embodiment is comprising the above-described active carbon particles and the cellulose nanofibers or the like as the above-described fibers, which bind to each other.

Although a mechanism is uncertain by which the active carbon particles and the cellulose nanofibers or the like as the fibrous binder bind to each other to form the granulated body, the following reason is conceivable, for example.

First, the fibrous binder and the active carbon particles become entangled with one another, whereby mechanical strength is provided.

The active carbon granules according to the present embodiment are produced as granulated bodies having the fibrous binder and the active carbon particles entangled with one another, by a method of producing the active carbon granules to be described later.

Further, the surface of active carbon particles is not completely hydrophobic, and several percent of oxygen is present on the surface of active carbon in the form of a carboxy group or a hydroxy group.

Similarly, on the surface of cellulose nanofibers or the like, a hydroxy group deriving from cellulose is present.

Therefore, it is presumed that hydrogen bonds exist between the surface of active carbon and the cellulose nanofibers, whereby the firm granulated body is formed.

Note that the “bond” and “bind” as used in the description of the present invention refer to a concept including the mechanical bond due to entanglement of the above-described fibrous binder and the active carbon particles and the chemical bond such as the hydrogen bond.

The fibrous binder included in the active carbon granule according to the present embodiment has a particle diameter D₅₀, as measured by a laser diffraction method, of 3.5 μm to 86.7 μm

The particle diameter of the fibrous binder of the present invention is measured while the whole fiber having the shape of a substantially circular column is regarded as a particle. Thus, the particle diameter is determined with the fiber diameter and the height of the circular column taken into account.

If the fibrous binder has a large particle diameter and a high strength, the active carbon particles are pushed away by the elastic force of the fibrous binder in a granulation process. For this and other reasons, it becomes difficult for the active carbon particles to be entangled with the binder fibers, thereby making it difficult to form the active carbon granules.

On the other hand, if the fibrous binder has a small particle diameter, the fibers, which are short and thin, retain the active carbon particles caught among them with a weak force, thereby making the active carbon granules prone to collapsing.

The fibrous binder having a particle diameter within the above range enables reliable formation of highly strong granules of active carbon.

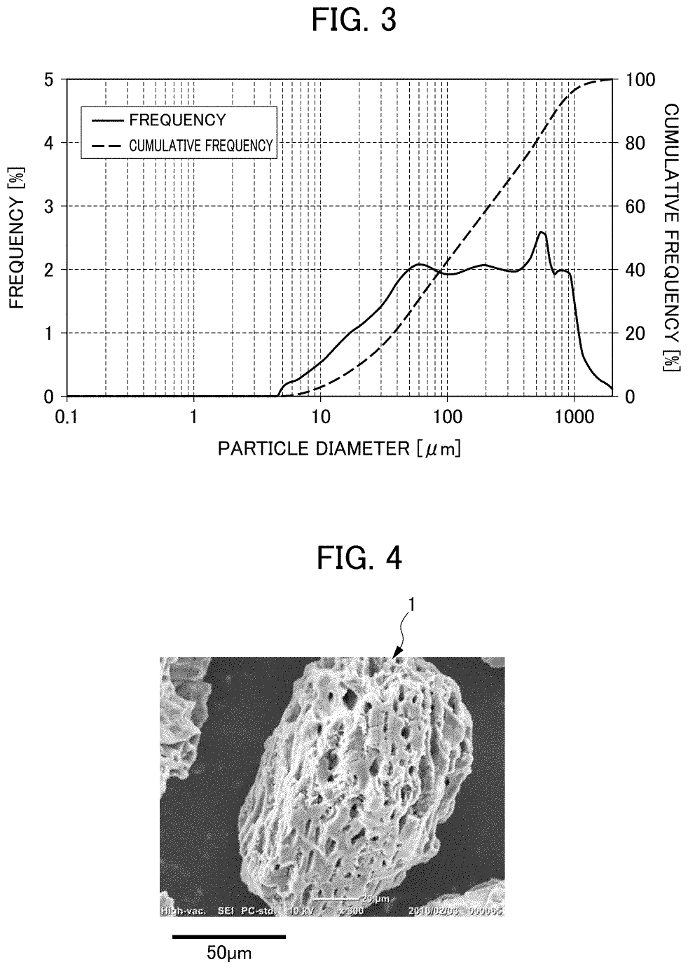

FIG. 3 is a graph showing the particle size distribution of binder fibers.

A commercially-available fibrous binder compound includes many particles that are substantially equivalent in terms of the fiber diameter and the fiber length. Taking this into consideration, reference is made to the peak of the solid line graph approximately corresponding to the particle diameter range from 50 μm to 1000 μm. It is presumed that the left shoulder of the peak represents the fiber diameters and the right shoulder represents the fiber lengths.

<Water Purification Cartridge>

The water purification cartridge according to the present embodiment is for use in a water purifier for purifying water to be treated, such as tap water, and includes the active carbon granules described above.

The water purification cartridge according to the present embodiment is not particularly limited.

The active carbon granules to be included in the water purification cartridge are, for example, dispersed in water and converted into a slurry, and then, subjected to suction molding so as to be used as the active carbon molded body.

The active carbon molded body may further include fibril fibers or an ion-exchange material.

The water purification cartridge according to the present embodiment may further include a ceramic filter or the like as a support for supporting the active carbon molded body, a filter such as a hollow fiber membrane, or a nonwoven fabric or the like for protecting the surface of the active carbon molded body.

<Method of Producing Active Carbon Granules>

A method of producing the active carbon granules according to the present embodiment includes a stirring step, a granulation step, and a dehydration step.

First, in the stirring step, active carbon particles pulverized and classified by a known method and having an arbitrary particle diameter, a fibrous binder such as nanofibers, and water are mixed together and stirred, thereby obtaining a slurry-like raw material mixture.

Next, in the granulation step, the raw material mixture is granulated.

Although any granulation process may be used, the granulation can be performed using a spray dryer method, for example. According to the spray dryer method, the raw material mixture is loaded into a spray dryer and spray dried, whereby granules of the raw material mixture are obtained.

The granules can be made to have a desired size by appropriately adjusting parameters, such as an ejection pressure of the spray dryer, a nozzle diameter, a circulating air volume, and a temperature.

Using the spray dryer method makes it possible to produce the granulated bodies (in a dry state) including the active carbon particles and the fibrous binder that are entangled with one another.

Note that as a method of adjusting the particle diameter of the fibrous binder of the present invention, defibrating can be carried out using a strong shearing force of a high-pressure homogenizer or the like. A fibrous binder is processed according to this defibrating method while the pressure conditions and the number of processing times are appropriately adjusted, whereby the fibrous binder can be made to have a desired particle diameter.

Following the granulation step, the dehydration step is carried out in which the formed granules of the raw material mixture are placed in a heating furnace and dehydrated.

The heating temperature is not particularly limited, and may be set to, for example, about 130° C.

The dehydration in the dehydration step firms up the granulated bodies of the active carbon particles and the fibrous binder, such that the structure of the granulated bodies does not collapse even when the granulated bodies are placed into water.

Through the steps described above, the active carbon granules according to the present embodiment can be produced.

The above-described active carbon granules according to the present embodiment are superior in purification performance to the conventional active carbon particles.

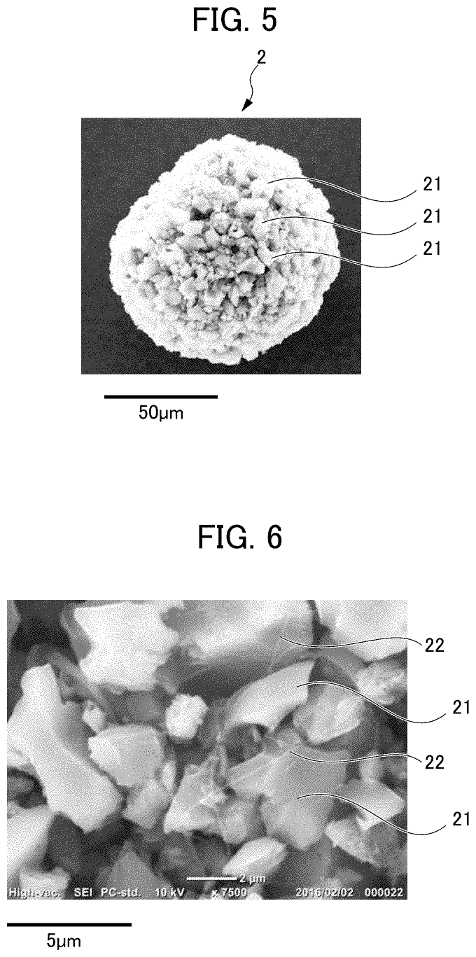

FIG. 4 is a photograph of a conventional active carbon particle. FIG. 5 is a photograph of the active carbon granule according to the present embodiment. Both photographs were taken by a scanning electron microscope after the particles and the granules had been sifted through a sieve of 63 μm/90 μm (170 mesh/230 mesh) so as to have a similar particle size distribution.

FIG. 4 shows the conventional active carbon particle 1, whereas FIG. 5 shows the active carbon granule 2 according to the present embodiment that includes the active carbon particles 21.

FIG. 5 is a photograph of the active carbon granule 2 according to the present embodiment, taken on a further enlarged scale by a scanning electron microscope.

As is apparent from FIG. 6, the active carbon particles 21 and the fibers 22, which are entangled with one another, form the granulated body, without a binder resin.

As is apparent from FIGS. 4 and 5, the active carbon granule 2 according to the present embodiment is formed by granulating the active carbon particles 21 that have a smaller particle diameter than the conventional active carbon particle 1, and is superior in specific surface area.

In the present embodiment, any method of determining the presence or absence of the granulated body may be used. For example, the presence or absence of granulated body can be determined by observation using an electron microscope or the like.

The active carbon granules according to the present embodiment preferably have a median particle diameter D₂ greater than 40 μm although the median particle diameter D₂ is not particularly limited.

The active carbon granules having a median particle diameter D₂ greater than 40 μm are less prone to densification, thereby making it less likely for the resistance to water flow to increase.

The median particle diameter D₂ is preferably 2 mm or less. Adjusting the median particle diameter D₂ to 2 mm or less can cause the active carbon granules to have smaller voids among them, and can increase the entire active carbon in the adsorption amount per volume.

From this viewpoint, it is more preferable to adjust the median particle diameter D₂ to 150 μm or less.

Like the median particle diameter D₁, the median particle diameter D₂ is a value measured by the laser diffraction method, and refers to the value of a 50% diameter (D₅₀) in volume-based cumulative fraction.

The above-described active carbon granules according to the present embodiment exert the following effects.

(1) The granulation-purpose fibrous binder has a particle diameter D₅₀ of 3.5 μm to 86.7 μm.

With this feature, the fibrous binder can catch and retain active carbon particles to a sufficient extent, thereby enabling formation of reliable and highly strong granules of active carbon.

(2) The particle diameter D₅₀ of the fibrous binder is set to 13.8 μm to 59.0 μm.

This feature further ensures the above-described effect.

(3) The fibrous binder according to (1) and (2) has a particle diameter D₉₀ of 11.0 μm to 522.3 μm.

This feature further ensures the above-described effect.

(4) The fibrous binder according to (1) through (3) has a particle diameter D₁₀ of 0.8 μm to 18.2 μm.

This feature further ensures the above-described effect.

(5) The fibrous binder according to (1) through (4) is made of an acrylic material or cellulose.

This feature further ensures the above-described effect.

(6) Filter medium granules for treating water are produced using the granulation-purpose fibrous binder according to (1) through (5). The filter medium granules cause an increase in the specific surface area of a filter medium molded body. The filter medium granules for treating water exhibit high purification performance.

(7) The filter medium granules for treating water according to (6) further include active carbon or an ion exchanger.

The adsorbability of active carbon and the ion exchangeability of the ion exchanger contribute to high purification performance of the produced filter medium granules.

Note that the present invention is not limited to the embodiment described above, but encompasses modifications and improvements within the range in which the object of the present invention can be achieved.

Although cellulose nanofibers and the like have been described as examples of the fibrous binder of the present invention, the fibrous binder is not limited to the cellulose nanofibers and the like, and may be any binder as long as granulated bodies can be formed using it.

### EXAMPLES

The present invention will be described further in detail with reference to examples. Note that the present invention is not limited to the following examples.

### Examples and Comparative Examples

Active carbon granules according to Examples were produced by the following method.

First, active carbon was pulverized and classified so that active carbon particles were produced.

Cellulose nanofibers and water were added to the active carbon particles. The D₅₀ of the cellulose nanofibers ranged from 3.5 μm to 86.7 μm. The particles and the nanofibers were dispersed by way of stirring, whereby a slurry-like mixture was obtained. The slurry-like mixture was processed using a spray drier, and thereafter, dehydrated by being heated at about 130° C. in a heating furnace. As a result, granulated bodies were obtained.

The obtained granulated bodies were classified using a 170/325 mesh sieve, whereby active carbon granules were obtained. Table 1 shows whether the formation of active carbon granules was successful or failed in Examples and Comparative Examples.

(In Table 1, “A” indicates success in the formation of the granules, and “B” indicates failure in the formation.)

The cellulose nanofibers were processed with a high-pressure homogenizer under the conditions shown in Table 1, whereby the particle diameters were adjusted.

To determine the particle diameters, particle size distribution was measured using MT3000II (manufactured by MicrotracBEL Corp.) by a laser diffraction method, and the D₁₀, D₅₀, and D₉₀ were identified.

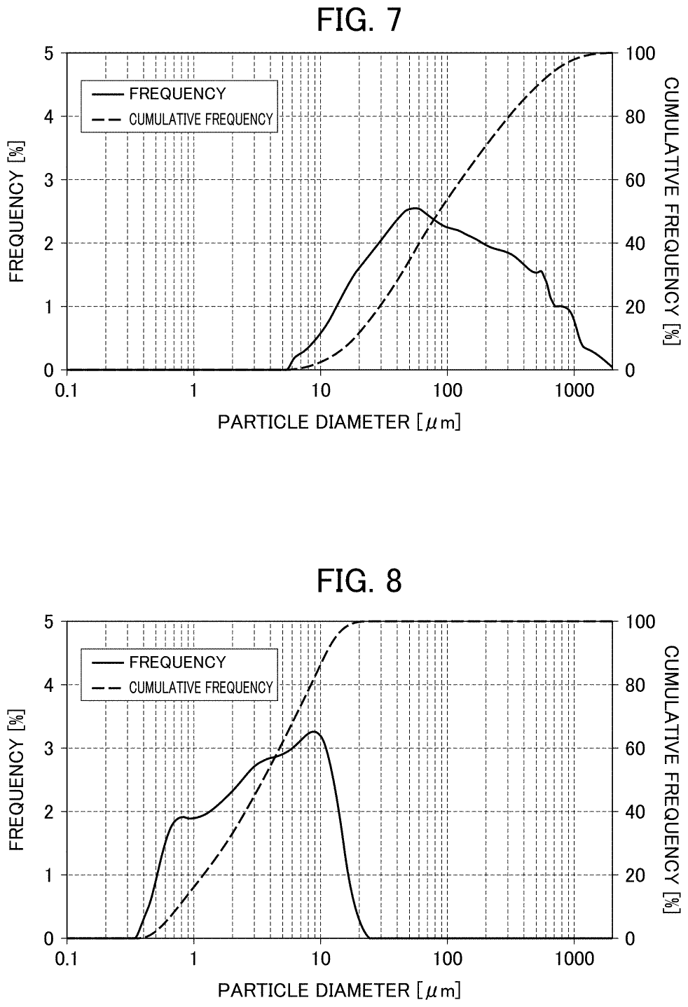

FIG. 7 shows the particle size distribution of Example 1 that indicates the upper limit of the D₅₀ below which the granules can be formed. FIG. 8 shows the particle size distribution of Example 18 that indicates the lower limit of the D₅₀ above which the granules can be formed.

The active carbon granules of each of Examples and Comparative Examples were molded into a shape having dimensions of ϕ24.7 mm×ϕ8.3 mm×90 mm length. The molded body was subjected to a water flow test. The water flow test was performed at a water-supply pressure of 0.75 MPa.

A flow rate was measured one minute and ten minutes after the water flow was started. If no decrease was observed in the flow rate measured ten minutes later, the granules were evaluated to have a high strength.

The results of the water flow test are shown in Table 1.

(In Table 1, “A” indicates a high strength, “B” indicates a strength allowing water to pass, and “-” indicates that the water flow test was not performed due to the failure in the formation of the granules.

TABLE 1

| | Comparative | Comparative | Comparative | | | |
|---|---|---|---|---|---|---|
| | Example 1 | Example 2 | Example 3 | Example 1 | Example 2 | Example 3 |
| D10(μm) | 21.1 | 23.4 | 23.4 | 18.2 | 13.3 | 11.2 |
| D50(μm) | 134.8 | 133.1 | 108.7 | 86.7 | 60.9 | 48.6 |
| D90(μm) | 764.8 | 701.4 | 625.4 | 522.3 | 393.1 | 318.5 |
| Success or Failure in | B | B | B | A | A | A |
| Formation of Granules | | | | | | |
| Water Flow Test | — | — | — | B | B | B |
| Processing Pressure (MPa) | — | 0.8 | 20 | 20 | 20 | 20 |
| Number of Processing Times | — | 1 | 1 | 5 | 10 | 15 |
| (Times) | | | | | | |

| | Example 4 | Example 5 | Example 6 | Example 7 | Example 8 |
|---|---|---|---|---|---|
| D10(μm) | 10.2 | 9.9 | 9.3 | 14.7 | 12.3 |
| D50(μm) | 40.1 | 38.6 | 36.4 | 59.0 | 50.8 |
| D90(μm) | 267.6 | 256.3 | 218.9 | 242.5 | 221.0 |
| Success or Failure in | A | A | A | A | A |
| Formation of Granules | | | | | |
| Water Flow Test | B | B | B | A | A |
| Processing Pressure (MPa) | 20 | 20 | 20 | 160 | 200 |
| Number of Processing Times | 20 | 25 | 30 | 1 | 1 |
| (Times) | | | | | |

| | Example 9 | Example 10 | Example 11 | Example 12 | Example 13 | Example 14 |
|---|---|---|---|---|---|---|
| D10(μm) | 10.0 | 6.7 | 5.9 | 5.3 | 5.3 | 5.6 |
| D50(μm) | 40.5 | 24.0 | 17.9 | 16.5 | 14.0 | 13.8 |
| D90(μm) | 173.8 | 147.4 | 105.9 | 86.3 | 63.1 | 35.4 |
| Success or Failure in | A | A | A | A | A | A |
| Formation of Granules | | | | | | |
| Water Flow Test | A | A | A | A | A | A |
| Processing Pressure (MPa) | 240 | 160 | 200 | 240 | 160 | 200 |
| Number of Processing Times | 1 | 3 | 3 | 3 | 5 | 5 |
| (Times) | | | | | | |

| | Example 15 | Example 16 | Example 17 | Example 18 |
|---|---|---|---|---|
| D10(μm) | 6.7 | 6.7 | 2.0 | 0.8 |
| D50(μm) | 13.3 | 12.6 | 8.2 | 3.5 |
| D90(μm) | 24.6 | 22.7 | 29.9 | 11.0 |
| Success or Failure in | A | A | A | A |
| Formation of Granules | | | | |
| Water Flow Test | B | B | B | B |
| Processing Pressure (MPa) | 200 | 160 | 240 | 240 |
| Number of Processing Times | 10 | 10 | 5 | 10 |
| (Times) | | | | |

Referring to FIG. 7, in the case where the D₅₀ is at the upper limit, the particle size distribution shows a high frequency in the vicinity of 50 μm, and widely extends up to particle diameters larger than 1000 μm.

It is estimated that the peak in the vicinity of 50 μm represents the fiber diameters and the values equal to or greater than 50 μm are associated with various fiber lengths of the group of binder particles.

Referring to FIG. 8, in the case where the D₅₀ is at the lower limit, the particle size distribution shows a high frequency in the vicinity of 10 μm, and few particles have a particle diameter larger than 20 μm.

Since the relationship between the fiber diameter and the fiber length can be reversed, the correspondence between the fiber diameter, the fiber length, and the particle size distribution is unknown in detail. However, it is apparent that in comparison with both the fiber diameter and the fiber length in FIG. 7, the binder fibers of FIG. 8 were cut into smaller fibers due to the difference in the conditions of the high-pressure homogenizer.

In Examples 1 to 18, in which the particle diameters D₅₀ were in the range from 3.5 μm to 86.7 μm, the active carbon granules were formed.

The active carbon granules of Examples 7 to 14 have a higher strength than those of the other examples.

Although the correlation between the particle diameters D₁₀, D₉₀, and D₅₀ is unknown in detail, the particle diameters D₁₀ and D₉₀ can be said to be in preferred diameter ranges at least within the ranges defined in Examples 1 to 18.

### EXPLANATION OF REFERENCE NUMERALS

1: Active Carbon Particle
2: Active Carbon Granule
21: Active Carbon Particle
22: Fibrous Binder

1. A fibrous binder having a particle diameter D₅₀, as measured by a laser diffraction method, of 3.5 μm to 86.7 μm,
wherein the particle diameter D₅₀ is defined as a value of a 50% diameter in volume-based cumulative fraction, the fibrous binder being usable for forming, by granulation, an active carbon granule comprising an aggregation of active carbon particles.

2. The fibrous binder according to claim 1, wherein the particle diameter D₅₀ is 13.8 μm to 59.0 μm.

3. The fibrous binder according to claim 1, having a particle diameter Do, as measured by the laser diffraction method, of 11.0 μm to 522.3 μm,
wherein the particle diameter D₉₀ is defined as a value of a 90% diameter in volume-based cumulative fraction.

4. The fibrous binder according to claim 1, having a particle diameter D₁₀, as measured by the laser diffraction method, of 0.8 μm to 18.2 μm,
wherein the particle diameter D₁₀ is defined as a value of a 10% diameter in volume-based cumulative fraction.

5. The fibrous binder according to claim 1, comprising an acrylic material or cellulose.

6. A filter medium granule for treating water, the filter medium granule comprising the fibrous binder according to claim 1.

7. The filter medium granule for treating water according to claim 6, the filter medium granule further comprising at least one of active carbon or an ion exchanger.
